(19) United States
(12) Patent Application Publication
(10) Pub. No.: US 2016/0258415 A9
(43) Pub. Date: Sep. 8, 2016

(54) WIND TURBINE HUB

(71) Applicant: ALSTOM RENEWABLE TECHNOLOGIES, Grenoble (FR)

(72) Inventors: Ricardo LÁZARO, Barcelona (ES); Laia ESTEBAN, Badalona (ES)

(21) Appl. No.: 14/559,865

(22) Filed: Dec. 3, 2014

(30) Foreign Application Priority Data
Dec. 17, 2013 (EP) 13382516.6

(51) Int. Cl. F03D 1/06; F03D 11/00

(52) U.S. Cl. CPC F03D 1/0691; F03D 11/0008

(57) ABSTRACT

In a first aspect, the invention provides a hub to be mounted on a wind turbine having a frame to be surrounded by the hub. The hub comprises a front bearing seat and a rear bearing seat for rotatably mounting the hub on the frame through respective front and rear bearings, in such a way that the frame is provided at least partially internally of the hub. The hub further comprises a plurality of beams connecting the front bearing seat and the rear bearing seat. In a second aspect, the invention provides a wind turbine comprising a hub according to the first aspect of the invention and a frame surrounded by the hub. The hub is rotatably mounted on the frame through respective front and rear bearings, in such a way that the frame is provided at least partially internally of the hub.

The present invention relates to a hub to be mounted on a wind turbine and to a wind turbine comprising such a hub.

### BACKGROUND ART

Modern wind turbines are commonly used to supply electricity into the electrical grid. Wind turbines of this kind generally comprise a tower and a rotor arranged on the tower. The rotor, which typically comprises a hub and a plurality of blades, is set into rotation under the influence of the wind on the blades. Said rotation generates a torque that is normally transmitted through a rotor shaft to a generator, either directly or through the use of a gearbox. This way, the generator produces electricity which can be supplied to the electrical grid.

EP2505822 A1 discloses a wind turbine comprising a hub carrying a plurality of blades, the hub being rotatably mounted on a frame, the frame extending forward into the hub. The hub is mounted on the frame through suitable bearings arranged at a front end and a rear end of the hub. The hub comprises a substantially tubular inner stiffening structure arranged between the front end and the rear end of the hub, coaxially arranged around the frame.

These bearings and possibly other components related to them, such as e.g. components associated with the lubrication of the bearings, may require inspection, repair or periodic replacement for e.g. planned maintenance reasons and/or occasionally in case turbine malfunction is noticed.

A drawback of the tubular stiffening structure of EP2505822 A1 may be that there may be relatively little space between the frame and the tubular stiffening structure, which may not permit the access (by e.g. maintenance personnel) from inside the hub to components in the vicinity of the bearings (through which the hub is mounted on the frame). At the very least, it makes the access to the bearings and associated systems (e.g. lubrication systems) very complicated, thus increasing operational costs and risks for the personnel.

The present invention aims at resolving at least some of the previous problems.

### SUMMARY OF THE INVENTION

In a first aspect, the present invention provides a hub to be mounted on a wind turbine having a frame to be surrounded by the hub. The hub comprises a front bearing seat and a rear bearing seat for rotatably mounting the hub on the frame through respective front and rear bearings, such that the frame is provided at least partially internally of the hub. The hub further comprises a plurality of beams connecting the front bearing seat and the rear bearing seat.

This configuration of front and rear bearings may require a certain stiffness to maintain the bearings non deformable and therefore prevent bearing rings to run out of true. Misalignment or misadjustment may increase the contact pressure of corresponding rollers. A suitable stiffness may also be required to maintain the relative position between the front and rear bearing seats and therefore prevent misalignment of the bearings, i.e. loss of their concentricity relative to the rotating axis, which e.g. may also increase the contact pressure of the rollers.

The proposed beams connecting the front and rear bearing seats may provide the required stiffness to this bearing seats configuration so as to substantially prevent both the bearing rings to run out of true and the misalignment of the bearing seats.

Access (by e.g. maintenance personnel) from inside the hub to the vicinity of the front and rear bearings may also be required. This access may enable or at least facilitate e.g. the inspection and/or reparation of components related to the bearings, such as e.g. lubrication components, sealing components (to prevent lubricant leakages), etc.

The proposed beams connecting the front and rear bearing seats may enable or at least facilitate said access from inside the hub to positions close to the front and rear bearings. Depending on the space between the beams, the proposed arrangement may permit/facilitate such an access (by e.g. maintenance personnel) substantially along the complete bearing ring circumference.

In some embodiments, the plurality of beams connecting the front and rear bearing seats may comprise at least three beams. An aspect of having more than two beams may be that this may make the hub itself and the hub-bearing-frame arrangement dynamically balanced.

In some configurations of the hub, each of the front and rear bearing seats may have substantially equispaced connection points at which the beams connect the bearing seats.

In examples of the hub, the front and rear bearing seats may have an identical number of connection points (at which the beams connect the bearing seats). In more particular configurations, the number of connection points of each front and rear bearing seats may be equal to the number of beams.

In some embodiments, the front and rear bearing seats may constitute a configuration of two rings with a common central axis, and the connection points of the front and rear bearing seats may be located in such a way that the beams are arranged substantially parallel to the common central axis.

In alternative configurations, however, one of the front and rear bearing seats may constitute a ring of smaller diameter than the ring constituted by the other bearing seat, such that the beams may be arranged substantially inclined with respect to the common central axis.

In embodiments of the hub, the beams may be sized and the corresponding connection points may be spaced in such a way that an average-size adult human can move between the beams. This way, a relatively easy access (by e.g. a repairman) from inside the hub to positions relatively close to the bearings may be permitted or at least facilitated.

According to exemplary configurations, the whole hub may be manufactured by using a single cast. Alternatively, the beams may be manufactured separately from the rest of the hub. In the case of the beams being manufactured separately from the rest of the hub, the beams may be made of a material with a greater stiffness in comparison with the stiffness of the material of the rest of the hub.

If the beams are manufactured separately from the rest of the hub, each of the beams may be coupled to the corresponding connection points by welding. Alternatively, each of the beams may be coupled to the corresponding connection points by screws, bolts or similar. In other alternative embodiments, each of the beams may be coupled to the corresponding connection points by a combination of welding and screws, bolts or similar.

In a second aspect, the invention provides a wind turbine comprising one of the previously described hubs and a frame surrounded by the hub. The hub is rotatably mounted on the frame through respective front and rear bearings, in such a way that the frame is provided at least partially internally of the hub.

This wind turbine may therefore cause the bearings to operate in a rather good condition while providing or at least facilitating access (by e.g. maintenance staff) from inside the hub to locations in the vicinity of the bearings. The stiffness between the bearing seats provided by the beams may cause said good operation of the bearings. The gap(s) (i.e. free space) between the beams may enable (or at least facilitate) to reach locations close to the bearings.

The wind turbine may further comprise a first lubricant chamber for lubricating the front bearing and a second lubricant chamber for lubricating the rear bearing. The first lubricant chamber may be located at the rear side of the front bearing. The second lubricant chamber may be located at the front side of the rear bearing.

According to some configurations, the wind turbine may further comprise, for each of the first and second lubricant chambers, a sealant to seal the lubricant chamber in order to avoid lubricant leakage towards the inside of the hub.

The abovementioned lubricant chambers and/or sealants may require to be reached by e.g. maintenance staff for e.g. periodical or punctual inspections or reparations. As discussed above with respect to different examples of the hub, the gap(s) or space(s) between the beams may permit or at least facilitate said access (by corresponding personnel) from the inside of the hub to positions relatively close to the lubricant chambers and/or the sealants.

### BRIEF DESCRIPTION OF THE DRAWINGS

Particular embodiments of the present invention will be described in the following by way of non-limiting examples, with reference to the appended drawings, in which:

FIG. 1 is a schematic representation of a perspective view of a hub according to an embodiment provided by the invention;

FIG. 2 is a schematic representation of a perspective cutaway view of a hub similar to the one shown in FIG. 1;

FIG. 3 is a schematic representation of an enlarged view of a hub front region from FIG. 2; and

FIG. 4 is a schematic representation of an enlarged view of a hub rear region from FIG. 2.

### DETAILED DESCRIPTION OF EMBODIMENTS OF THE INVENTION

In the following description, numerous specific details are set forth in order to provide a thorough understanding of examples of the present invention. It will be understood by one skilled in the art however, that examples of the present invention may be practiced without some or all of these specific details. In other instances, well known elements have not been described in detail in order not to unnecessarily obscure the description of the present invention.

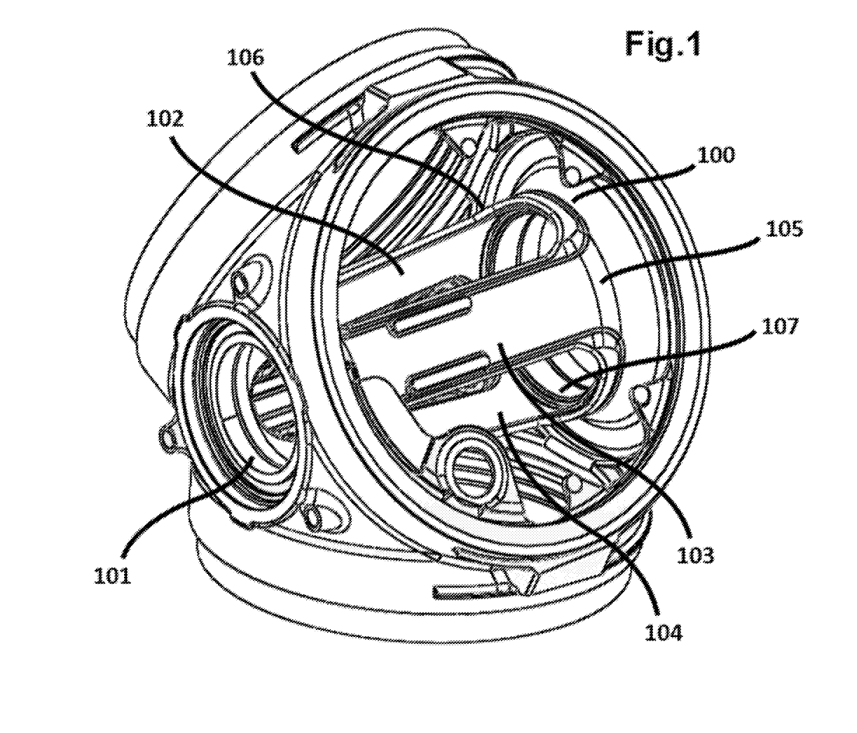

FIG. 1 is a schematic representation of a perspective view of a hub according to an embodiment provided by the invention. The hub is shown having a front bearing seat 101, a rear bearing seat 100 and three beams 102, 103, 104 connecting the front and rear bearing seats 101, 100. In alternative embodiments, the hub may comprise other numbers of beams, such as e.g. four. In the particular example of this figure, the hub is not shown rotatably mounted on a corresponding frame.

The beam 102 connects the bearing seats 101, 100 at a connection point (not shown) of the front bearing seat 101 and at a connection point 106 of the rear bearing seat 100. Each of the other beams 103, 104 connects the bearing seats 101, 100 in the same way that the beam 102 does. FIG. 1 further shows a corresponding connection point 105 of the beam 103 with the rear bearing seat 100, and a corresponding connection point 107 of the beam 104 with the rear bearing seat 100.

The connection points or regions 105, 106, 107 of the rear bearing seat 100 are shown substantially equispaced along the 360° of the rear bearing seat 100. The connection points (not shown) of the front bearing seat 101 may also be distributed equispaced along the 360° of the front bearing seat. In other embodiments, the connection points of the front and/or rear bearing seats may not be equispaced depending on e.g. the arrangement of other components in the hub, such as e.g. pitch boxes, supports for lubricating pitch bearings, etc.

FIG. 1 shows the front and rear bearing seats 101, 100 constituting a configuration of two rings with a common central axis, wherein the ring corresponding to the front bearing seat 101 has a diameter smaller than the ring corresponding to the rear bearing seat 100. The beams 102, 103, 104 are therefore arranged substantially inclined with respect to the common central axis.

In alternative embodiments, the ring corresponding to the front bearing seat 101 and the ring corresponding to the rear bearing seat 100 may be of substantially identical diameter. Besides, the connection points 105, 106, 107 of the front and rear bearing seats 101, 100 may be located in such a way that the beams 102, 103, 104 are arranged substantially parallel to the common central axis.

The beams 102, 103, 104 may be sized and the corresponding connection points 105, 106, 107 may be spaced in such a way that an average-size adult human can move through the gaps between the beams 102, 103, 104. In other examples, the beams could be placed closer together, but still with enough empty space between them that maintenance (e.g. substituting a seal or inspection of a bearing) is possible.

The whole hub of FIG. 1 (including the beams 102, 103, 104) has been manufactured by using a single cast. In other configurations, nevertheless, the beams 102, 103, 104 may be manufactured separately from the rest of the hub.

An aspect of using a single cast may be that fabrication of the hub may be simpler and cheaper. An aspect of manufacturing the beams 102, 103, 104 separately from the rest of the hub may be that different materials may be used for the beams 102, 103, 104 and for the rest of the hub. The material used for the beams 102, 103, 104 may be e.g. stiffer than the material used for fabricating the rest of the hub. For example, the beams 102, 103, 104 may be made of steel and the rest of the hub may be made of cast iron.

In case of the beams 102, 103, 104 are made of a material stiffer than the material of the rest of the hub, the beams 102, 103, 104 may be less bulky than the ones shown in FIG. 1. This way, the gaps between the beams 102, 103, 104 may be larger, such that access from the inside of the hub to the vicinity of the bearing seats 100, 101 may be easier.

If the beams 102, 103, 104 are fabricated separately from the rest of the hub, each of the beams 102, 103, 104 may be coupled to the corresponding connection points 105, 106, 107 by welding. In alternative embodiments, each of the beams 102, 103, 104 may be coupled to the corresponding connection points 105, 106, 107 by respective screws, bolts or similar. In other alternative embodiments, combinations of welding and screws or bolts may be used.

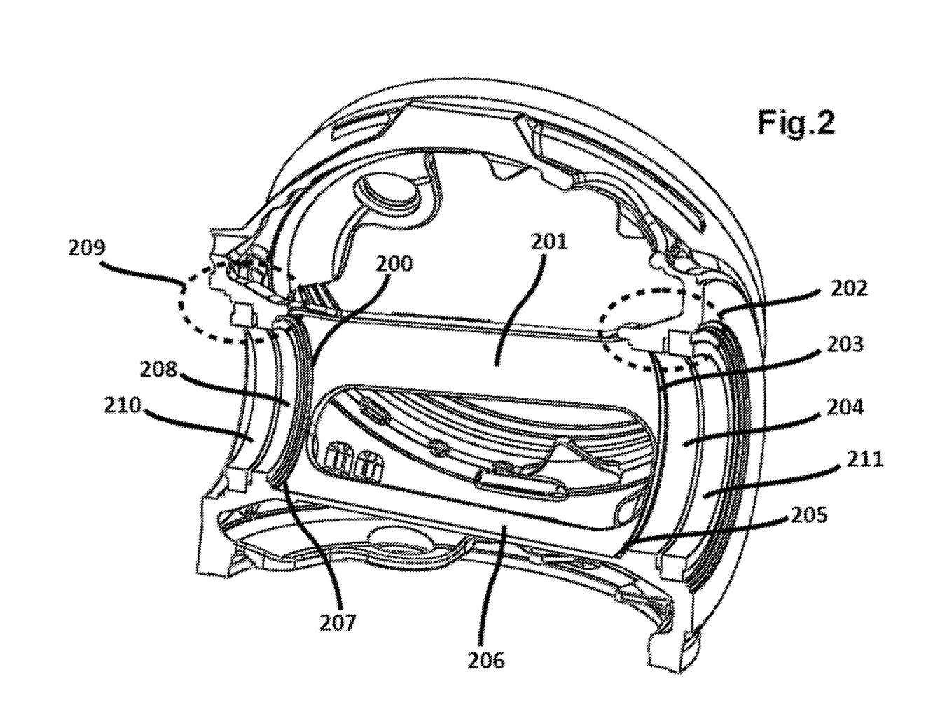

FIG. 2 is a schematic representation of a perspective cutaway view of a hub similar to the one shown in FIG. 1. In this view, the “partial” hub is shown having a front bearing seat 208, a rear bearing seat 204, a complete beam 201 and a “cut” beam 206. The beam 201 is shown connecting the front and rear bearing seats 208, 204 at a connection region 200 of the front bearing seat 208 and at a connection region 203 of the rear bearing seat 204. The (“cut”) beam 206 is shown connecting the front and rear bearing seats 208, 204 at a connection region 207 of the front bearing seat 208 and at a connection region 205 of the rear bearing seat 204. Both the front bearing ring 210 and the rear bearing ring 211 are also shown. In this view, the hub is not shown rotatably mounted on a corresponding frame.

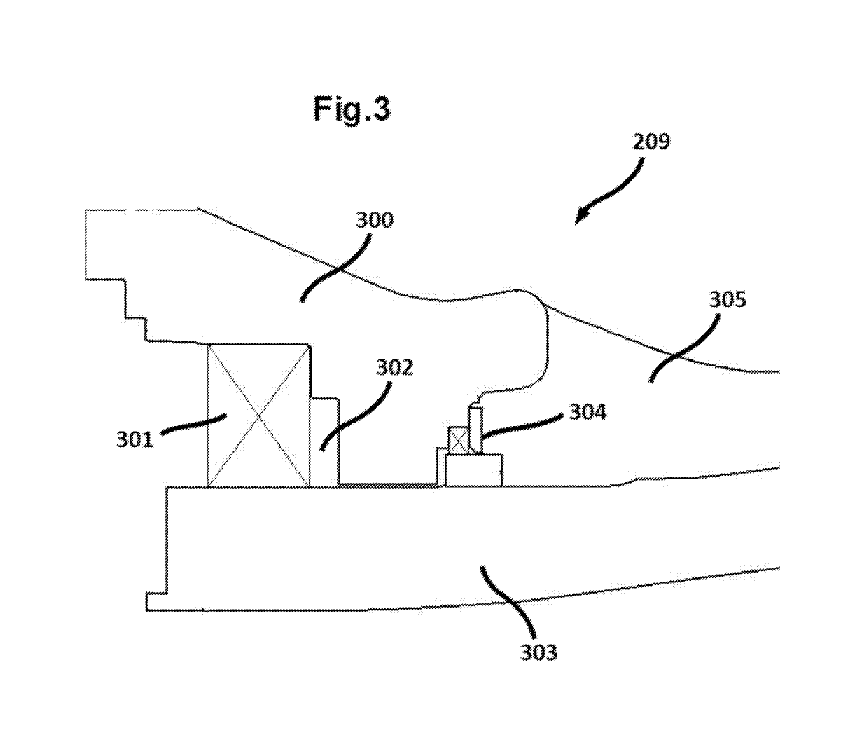

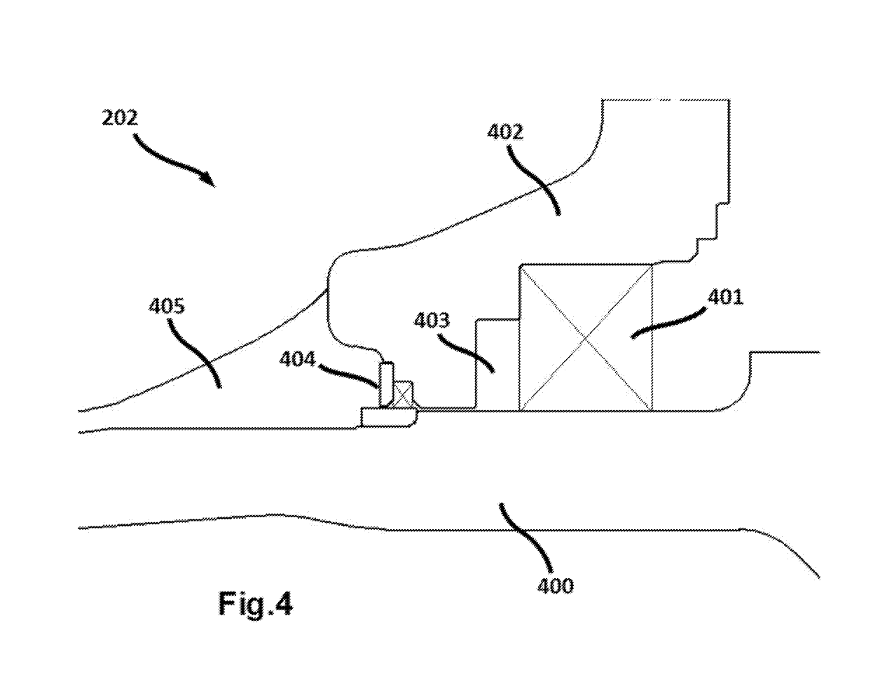

FIG. 2 further shows a relevant front region 209 of the hub and a relevant rear region 202 of the hub. Said front region 209 and said rear region 202 will be described in detail bellow with reference to FIG. 3 and FIG. 4 respectively.

FIG. 3 is a schematic representation of an enlarged view of the abovementioned hub front region 209 (of FIG. 2). FIG. 4 is a schematic representation of an enlarged view of the abovementioned hub rear region 202 (of FIG. 2). In both FIGS. 3 and 4, the reader must understand that the hub is rotatably mounted on a frame (portions 303, 400 of which are shown in FIGS. 3 and 4) in such a way that the frame is provided at least partially internally of the hub. In particular, the hub is rotatably mounted on the frame through a front bearing (a portion 301 of which is shown in FIG. 3) and a rear bearing (a portion 401 of which is shown in FIG. 4).

FIG. 3 shows a front portion 303 of the frame, a front bearing portion 301, a front bearing seat portion 300, and a front portion 305 of a beam connecting the front bearing seat 300 and a rear bearing seat (a portion 402 of which is shown in FIG. 4). FIG. 3 also shows a portion 302 of a grease or oil chamber and a portion 304 of a sealing. The grease or oil chamber 302 is arranged for providing suitable lubrication to the front bearing 301, and the sealing 304 is arranged for preventing the grease/oil to leak out from the chamber 302 towards the inside of the hub.

FIG. 4 shows a rear portion 400 of the frame, a rear bearing portion 401, a rear bearing seat portion 402, and a rear portion 400 of the beam connecting the front bearing seat (a portion 300 of which is shown in FIG. 3) and the rear bearing seat 402. FIG. 4 also shows a portion 403 of a grease or oil chamber and a portion 404 of a sealing. The grease or oil chamber 403 is arranged for providing suitable lubrication to the rear bearing 401, and the sealing 404 is arranged for preventing the grease/oil to leak out from the grease/oil chamber 403 towards the inside of the hub.

In configurations as the one depicted in FIGS. 3 and 4, the sealing 304, 404 may require its inspection, reparation or replacement periodically because it may deteriorate over time. The gap(s) or free space(s) between the beams 102, 103, 104 (see FIG. 1) permits or at least facilitates to reach the sealing 304, 404 for its inspection, reparation or replacement. In prior art configurations based on e.g. a tubular stiffening structure there is a little space between the corresponding frame and the tubular stiffening structure, so reaching the sealing 304, 404 can be a rather complicated (even impossible) task.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

1. A hub to be mounted on a wind turbine having a frame to be surrounded by the hub; the hub comprising:
a front bearing seat and a rear bearing seat for rotatably mounting the hub on the frame through respective front and rear bearings, in such a way that the frame is provided at least partially internally of the hub; and
a plurality of beams connecting the front bearing seat and the rear bearing seat.

2. The hub according to claim 1, wherein:
the plurality of beams connecting the front and rear bearing seats comprises at least three beams.

3. The hub according to claim 1, wherein:
each of the beams connects the front and rear bearing seats at respective connection points of the front and rear bearing seats.

4. The hub according to claim 3, wherein:
the beams are sized and the corresponding connection points are spaced in such a way that an average-size adult human can move between the beams.

5. The hub according to claim 3, wherein:
each of the front and rear bearing seats has its connection points substantially equispaced.

6. The hub according claim 3, wherein:
the front and rear bearing seats have an identical number of connection points.

7. The hub according to claim 6, wherein:
the number of connection points of each of the front and rear bearing seats is equal to the number of beams connecting the front and rear bearing seats.

8. The hub according to claim 6, wherein:
the front and rear bearing seats constitute a configuration of two rings with a common central axis;
the connection points of the front and rear bearing seats are located in such a way that the beams are arranged substantially parallel to the common central axis.

9. The hub according to claim 3, wherein:
the whole hub is manufactured by using a single cast.

10. The hub according to claim 3, wherein:
the beams are manufactured separately from the rest of the hub.

11. The hub according to claim 10, wherein:
the beams are made of a material with a stiffness greater than the stiffness of the material of the rest of the hub.

12. The hub according to claim 10, wherein:
each of the beams is coupled to the corresponding connection points by welding and/or by screws or bolts.

13. A wind turbine comprising:
a hub according to claim 1, and
a frame surrounded by the hub;
wherein:
the hub is rotatably mounted on the frame through respective front and rear bearings, in such a way that the frame is provided at least partially internally of the hub.

14. The wind turbine according to claim 13, further comprising:
a first lubricant chamber for lubricating the front bearing and a second lubricant chamber for lubricating the rear bearing;
wherein:
the first lubricant chamber is located at the rear side of the front bearing, and the second lubricant chamber is located at the front side of the rear bearing.

15. The wind turbine according to claim 14, further comprising:
for each of the first and second lubricant chambers: a sealant to seal the lubricant chamber in order to avoid lubricant leakage towards the inside of the hub.

16. The hub according to claim 2, wherein:
each of the beams connects the front and rear bearing seats at respective connection points of the front and rear bearing seats; and wherein:
the beams are sized and the corresponding connection points are spaced in such a way that an average-size adult human can move between the beams.

17. The hub according to claim 16, wherein:
the beams are manufactured separately from the rest of the hub.

18. The hub according to claim 17, wherein:
the beams are made of a material with a stiffness greater than the stiffness of the material of the rest of the hub.

19. A wind turbine comprising:
a hub according to claim 2; and
a frame surrounded by the hub;
wherein:
the hub is rotatably mounted on the frame through respective front and rear bearings, in such a way that the frame is provided at least partially internally of the hub.

20. A wind turbine comprising:
a hub according to claim 16; and
a frame surrounded by the hub;
wherein:
the hub is rotatably mounted on the frame through respective front and rear bearings, in such a way that the frame is provided at least partially internally of the hub.
